(19) United States
(12) Patent Application Publication
(10) Pub. No.: US 2006/0004630 A1
(43) Pub. Date: Jan. 5, 2006

(54) Advertising through digital watermarks

(75) Inventors: Linda Criddle, Kirkland, WA (US); David Milstein, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/884,447

(22) Filed: Jul. 2, 2004

(51) Int. Cl. G06Q 99/00

(52) U.S. Cl. 705/14

(57) ABSTRACT

Various aspects of displaying digital watermark advertisements with display content on a client device is presented. According to one embodiment, in response to a content request from a client device, a content provider obtains a digital advertisement from an ad provider. The content provider combines the digital advertisement with the content and returns it to the client device, such that the digital advertisement is displayed as a digital watermark advertisement to the content on the client device. Digital advertisements may be pre-loaded onto a client device, such as during idle times. A digital advertisement is then selected for display on the display device according to an advertisement selector.

### FIELD OF THE INVENTION

The present invention relates to computing devices and software, and more particularly, to displaying digital advertising on computing devices as digital watermarks.

### BACKGROUND OF THE INVENTION

In a market-driven society, vendors constantly seek for methods to present their advertisements to consumers. While traditional methods of newsprint, television, radio, and the like, are all still effective, vendors have also turned to other advertisement mediums to present their advertisements to consumers. In particular, many vendors have turned to placing digital advertisements on a computer display. Indeed, one can hardly visit any site on the Internet without being presented with numerous advertisements from a variety of vendors. These advertisements are displayed on the computer in various forms, including banner advertisements, sidebar advertisements, pop-up displays, pop-under displays, audio advertisements, and animated advertisements to name just a few.

There are numerous drawbacks associated with current advertising mechanisms on computing devices. One of the most annoying drawbacks is that digital advertisements obscure, or otherwise restrict, the content for which a user visits a Web site. For example, FIG. 1 is a pictorial diagram illustrating an exemplary display device 100 connected to a computer. As shown on the display device 100, a user has directed a Web browser 102, such as Microsoft Corporation's® Internet Explorer, to a specific Web site for the content on that site. As can be seen in exemplary Web browser 102, the display window/view includes a banner advertisement 104, and three sidebar advertisements 106-110, in addition to the requested content 112. In this exemplary view, the advertisements 104-110 consume approximately one-third of the useable Web browser's display space, limiting the amount of content 1112, for which the user is visiting the Web site, that can be displayed to the user.

In addition to the advertisements 104-110 displayed in the Web browser's viewable space, pop-up advertisement 116 obscures some portion of the sought-for content 112. Still further, pop-under advertisement 114 is also displayed on the display device 100. While pop-under advertisements, such as pop-under advertisement 114, do not obscure the sought-for content 112, they may obscure other content on the display device 100, and most certainly represent an annoyance as the user must “clean” them off of the display device by individually dismissing each pop-up or pop-under ad.

Clearly, with large display screens, more content may be displayed in a Web browser in relation to the advertisement that accompanies the content. However, other computing devices, such as personal digital assistants (PDAs) and other handheld computing devices have a more limited display area. Thus, even small advertisements consume large portions of limited display space, severely impacting the amount of desired content that is displayable.

In light of the above-described deficiencies in current digital advertising techniques, what is needed is a system and method for displaying digital advertisements on computing devices while maximizing the available space for the desired content. The present invention addresses these and other issues found in the prior art.

### SUMMARY OF THE INVENTION

In accordance with aspects of the present invention, a networked environment for displaying a digital advertisement with content in a client device's display area is presented. The network environment includes a client device having a display area capable of displaying content and a digital advertisement as a digital watermark advertisement. The network environment also includes an ad provider that distributes digital advertisements over the network. The network environment further includes a content provider. The content provider is communicatively coupled to the ad provider and the client device. In response to a content request from the client device, the content provider combines the requested content with a digital advertisement obtained from the ad provider. The requested content and digital advertisement are combined such that when displayed, the digital advertisement is displayed as a digital watermark advertisement to the requested content. The content provider then returns the requested content combined with the digital advertisement to the client device for display on the client device's display area.

In accordance with other aspects of the present invention, a method for displaying content with a digital watermark advertisement on a client device is presented. A plurality of digital advertisements are obtained and stored on the client device. An advertisement selector for selecting one of the plurality of digital advertisements stored on the client device is received. A digital advertisement selected by the advertisement selector is displayed as a digital watermark advertisement along with other content on the client device.

In accordance with yet further aspects of the present invention, a method for displaying content and a digital advertisement on a client device while maximizing the display area for the content in the client device's display area is presented. A digital advertisement to be displayed in the display area is obtained. The digital advertisement is displayed in the display area as a digital watermark advertisement such that the entire display area is available for displaying content. Content is then displayed over the digital watermark advertisement in the display area

In accordance with still further aspects of the present invention, a method for displaying content and a digital advertisement on a mobile phone device, is presented, the mobile phone device having a display area capable of displaying content and a digital watermark advertisement. A digital advertisement is downloaded to the mobile phone device. The digital advertisement is displayed as a digital watermark advertisement on the mobile phone device's display area. Other content is displayed over the digital watermark advertisement on the mobile phone device's display area.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an exemplary display device connected to a computer, displaying advertisements according to current practices;

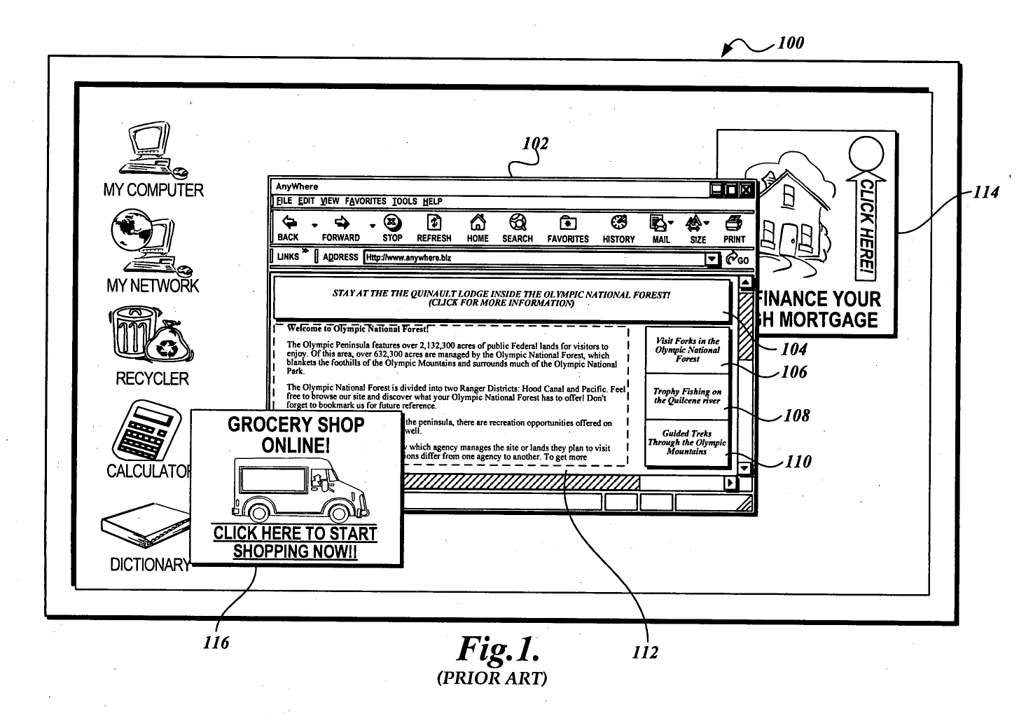

FIG. 2 is a pictorial diagram illustrating an exemplary computer display device having a Web browser displaying content from a Web site, and also displaying an associated advertisement as a digital watermark advertisement in the Web browser's display area;

FIG. 3 is a pictorial diagram illustrating an exemplary PDA displaying both content and a digital watermark advertisement in the display area of the PDA in accordance with the present invention;

FIG. 4 is a pictorial diagram illustrating an exemplary mobile phone displaying both content and a digital watermark in the mobile phone's display area, in accordance with the present invention;

FIG. 5 is a pictorial diagram of an exemplary network computing environment suitable for implementing aspects of the present invention;

FIG. 6 is a block diagram illustrating an exemplary exchange between a client device, such as the client computing device of FIG. 5, a content provider, and an ad provider for delivering content and a digital watermark advertisement to the client device;

FIG. 7 is a block diagram of an alternative exemplary networked environment suitable for implementing aspects of the present invention;

FIG. 8 is a block diagram illustrating an alternative exemplary exchange between a client device, such as the PDA of FIG. 3, a content provider, and an ad provider for pre-loading digital watermark advertisements onto the client device and subsequently selecting a digital watermark advertisement for display with content on the client device;

FIG. 9 is yet another alternative networked environment suitable for implementing aspects of the present invention;

FIG. 10 is a flow diagram illustrating an exemplary routine executed on a content provider for delivering content and a digital watermark advertisement in response to a content request from a client device;

FIG. 11 is a flow diagram illustrating an exemplary routine executed on a content provider for pre-loading a digital watermark advertisement onto a client device during an inactive period on the client device;

FIG. 12 is a flow diagram illustrating an exemplary routine executed on a service provider for transmitting an advertisement selector to a client device to display a pre-loaded digital watermark advertisement; and

FIG. 13 is a flow diagram illustrating an exemplary routine executed on a client device for displaying a digital watermark advertisement according to the advertisement selector sent from a service provider.

### DETAILED DESCRIPTION

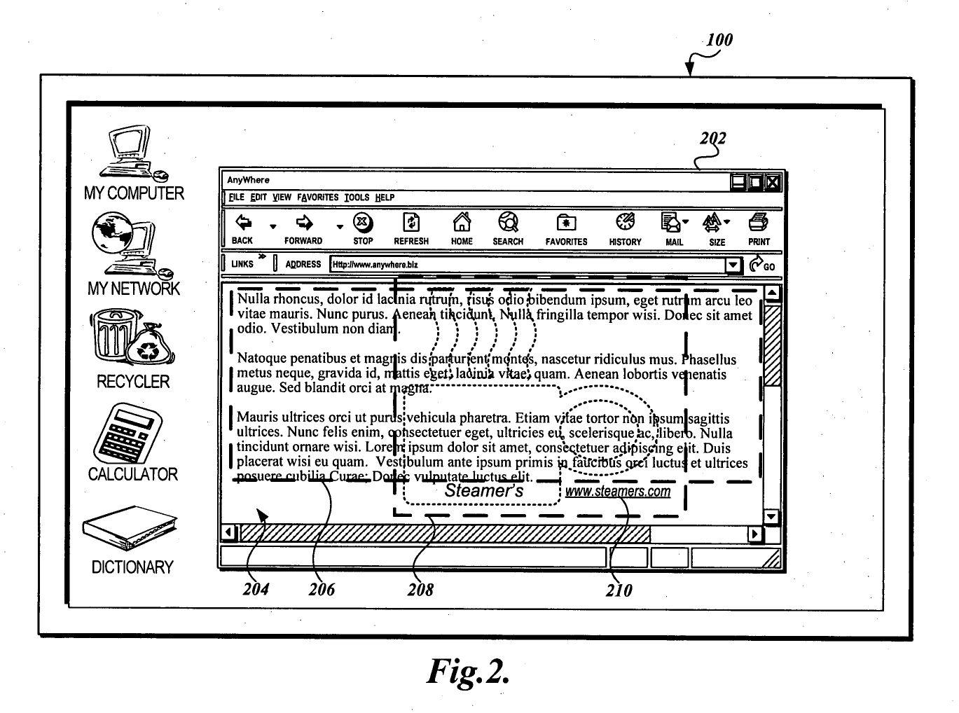

As mentioned above, the present invention addresses many issues in current practices related to digital advertising by displaying advertisements as digital watermarks behind content displayed on the display area of a client device. For example, FIG. 2 is a pictorial diagram illustrating an exemplary display device 100 connected to a client computing device (not shown) having a Web browser 202 displaying content 206 from a Web site, and also displaying an associated advertisement with the content as a digital watermark advertisement 208.

As shown in FIG. 2, the exemplary Web browser's display area 204 displays the digital watermark advertisement 208 as a background image to the content 206 of the particular Web site. Clearly, because the digital watermark advertisement 208 is displayed as a background image to the content 206, the Web browser's entire display area 204 is available for displaying the content 206 without being bounded by the digital watermark advertisement. In other words, the content is not restricted in its display by any particular advertisement 208. As those skilled in the art will appreciate, most content, such as content 206, is displayed with substantial white space, i.e., display area unoccupied by the content, through which a user may view a background image, such as the digital watermark advertisement 208.

While FIG. 2 is illustrated completely in black and white, according to aspects of the present invention, those skilled in the art will also appreciate that various colors may be advantageously used when displaying a digital watermark advertisement 208 (not shown). By using various colors to display a digital watermark advertisement 208, the digital watermark advertisement may be more easily viewed, made more visible, with minimal distractions from content 206. In addition to displaying a digital watermark advertisement 208 in various colors, the opacity of the digital watermark advertisement may be reduced such that the digital watermark advertisement is displayed as a semi-transparent image behind the content 206 (not shown), thereby further minimizing any content distractions.

According to aspects of the present invention, a digital watermark advertisement, such as digital watermark advertisement 208, may be considered either static or dynamic. A static digital watermark advertisement is one that is displayed simply as an unchanging background image to the displayed content 206. In contrast, a dynamic digital watermark advertisement is one that is displayed with some form of dynamic behavior, such as, but not limited to, graphic animation, movement, audio output, or any number of combinations of the above.

In addition to a digital watermark advertisement being either static or dynamic, another aspect of a digital watermark advertisement is whether the digital watermark advertisement is interactive or passive. An interactive digital watermark advertisement is one with which a user may interact. In other words, an interactive digital watermark advertisement is responsive to some user actions. In contrast, a passive digital watermark advertisement is one with which a user is unable to interact, or is unresponsive to user actions.

According to one embodiment of the present invention, the entire digital watermark advertisement 208 is a user-interactive region that, when activated by a user such as clicking on the digital watermark advertisement, carries out predetermined behaviors corresponding to the user interaction, such as displaying additional information related to the advertisement, or linking to another Web site. According to additional aspects of the present invention, when the entire digital watermark advertisement 208 represents a user-interactive region, those regions covered by the content 206 may be excluded as interactive regions.

According to another embodiment of the present invention, and as shown in FIG. 2, a digital watermark advertisement 208 may include specific, identifiable “hot zones” which, when acted upon by a user, cause an associated behavior to occur, such as linking. For example, link 210 of the digital watermark advertisement 208 links to another Web location. As such, digital watermark advertisement 208 is an interactive digital watermark advertisement. If link 210 represented nothing more than advertisement information, the digital watermark advertisement 208 could be said to be a passive digital watermark advertisement.

While FIG. 2 illustrates a digital watermark advertisement 208 embedded in, or displayed behind, the content 206 of a Web browser display area 204, it should be appreciated that the present invention is not so limited. In particular, the present invention is not limited to displaying digital watermarks in Web browser display areas 204, or displaying digital watermarks on display devices 100 attached to a computing device.

Digital watermark advertisements may be advantageously and beneficially used in any window or area displayed on a display device 100. For example, digital watermark advertisements may be advantageously displayed in the following: content display areas for any number of software applications, pull-down menus, and dialog boxes. For example, digital watermark advertisements may be displayed behind the content/results of an Internet search, or in conjunction with email, audio-visual, or instant messaging applications. Furthermore, the applications are not limited to those running on a traditional computer. For example, applications such as email, instant messaging, and the like, may display digital watermark advertisements, each running on a PDA or mobile device. Furthermore, digital watermark advertisements may be advantageously displayed as the background image of a display device 100, such as a computer's so-called desktop.

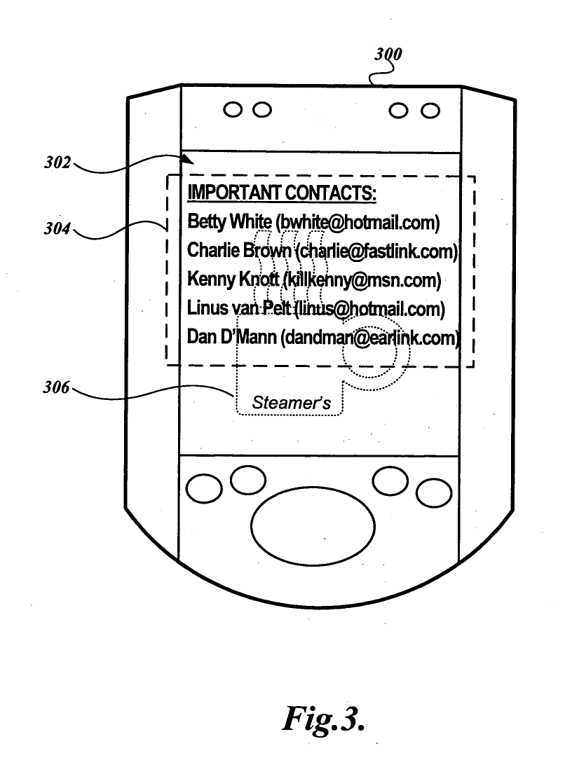

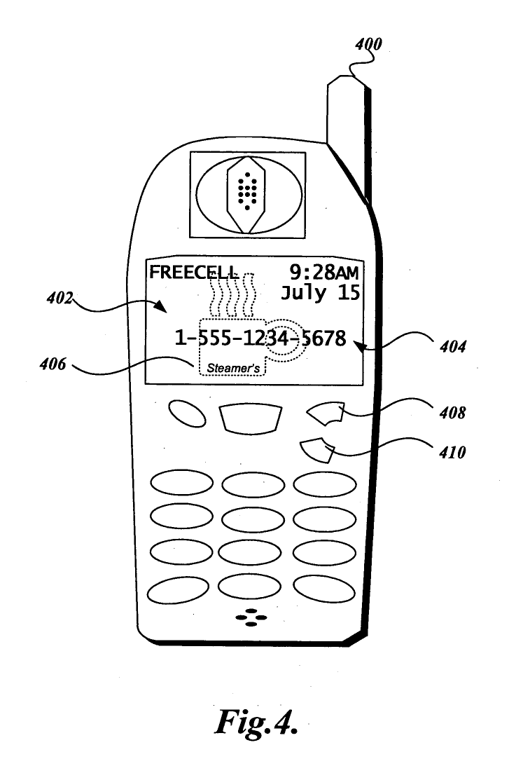

In addition to not being limited to any particular type of content display area, it should be further appreciated that the present invention is not limited to any particular client devices. Thus, while the present invention may be advantageously implemented on personal computers, tablet computers, notebook computers, workstations, and the like, the present invention may also be advantageously used in conjunction with more non-traditional client devices. These non-traditional client devices include, but are not limited to, personal digital assistants (PDAs), mobile phones having a display device, hybrid computing devices that combine both aspects of mobile phones and PDAs, and MP3 players having a display device In fact, the present invention may be advantageously used with almost any client device having a display device capable of displaying content over, or with, a background image. FIGS. 3 and 4 illustrate how the present invention may be implemented for use on some alternative client devices.

FIG. 3 is a pictorial diagram illustrating an exemplary PDA 300 with a display area 302 displaying both content 304 and a digital watermark advertisement 306 in accordance with the present invention. It should be noted that due to the nature of PDA display devices, more particularly that the display area 302 of a PDA 300 is typically pressure sensitive, the digital watermark advertisement 306 may be an interactive digital watermark advertisement. Additionally, as mentioned above in regard to FIG. 2, the digital watermark advertisement may be a dynamic digital watermark advertisement.

FIG. 4 is a pictorial diagram illustrating an exemplary mobile phone device 400 with a display area 402 displaying both content 404 and a digital watermark advertisement 406. As those skilled in the art will realize, the display area 402 on a mobile phone is typically not touch sensitive or otherwise user interactive. When the display area 402 of a client device, such as the mobile phone 400, is not user interactive, it would be unlikely that the digital watermark advertisement 406 is an interactive digital watermark advertisement. However, on some client devices a user may interact with a digital watermark advertisement 406 using an alternative means other than touch. Control buttons, a mouse, or other user-interaction devices may provide a conduit to interact with an interactive digital watermark advertisement. For example, control buttons 408 and 410 on the mobile phone device 400 could be used to interact with the digital watermark advertisement 406. In any event, it should be appreciated that the present invention is not limited to any particular type of a digital watermark advertisement, i.e., static versus dynamic and passive versus interactive, on any client device.

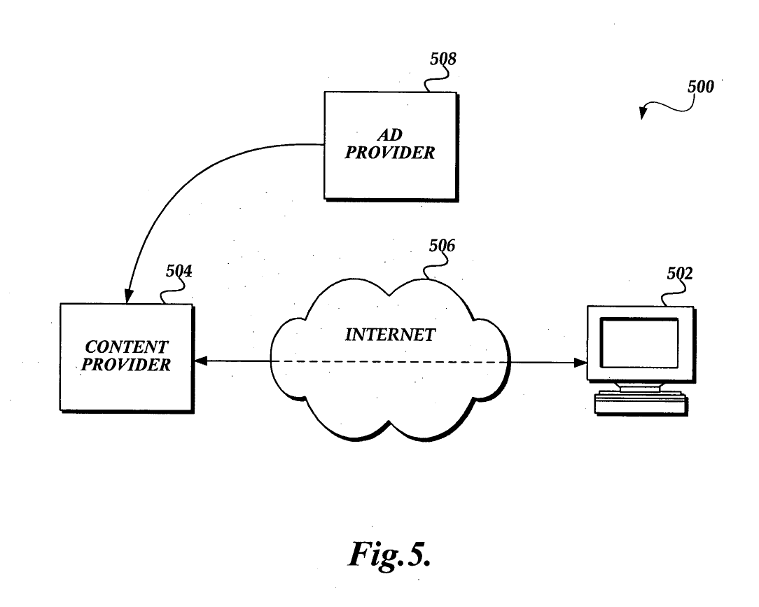

FIG. 5 is a pictorial diagram illustrating an exemplary networked environment for distributing content and a digital watermark advertisement to a client computing device 502 in accordance with aspects of the present invention. As illustrated in exemplary networked environment 500, a client computing device communicates with a content provider 504 over a network, such as the Internet 506. Thus, while FIG. 5 illustrates that communication between the client computing device 502 and the content provider 504 takes place over the Internet 506, in an actual embodiment, the client computing device may alternatively communicate with the content provider over a local area network (LAN) or a larger network, such as a wide area network (WAN).

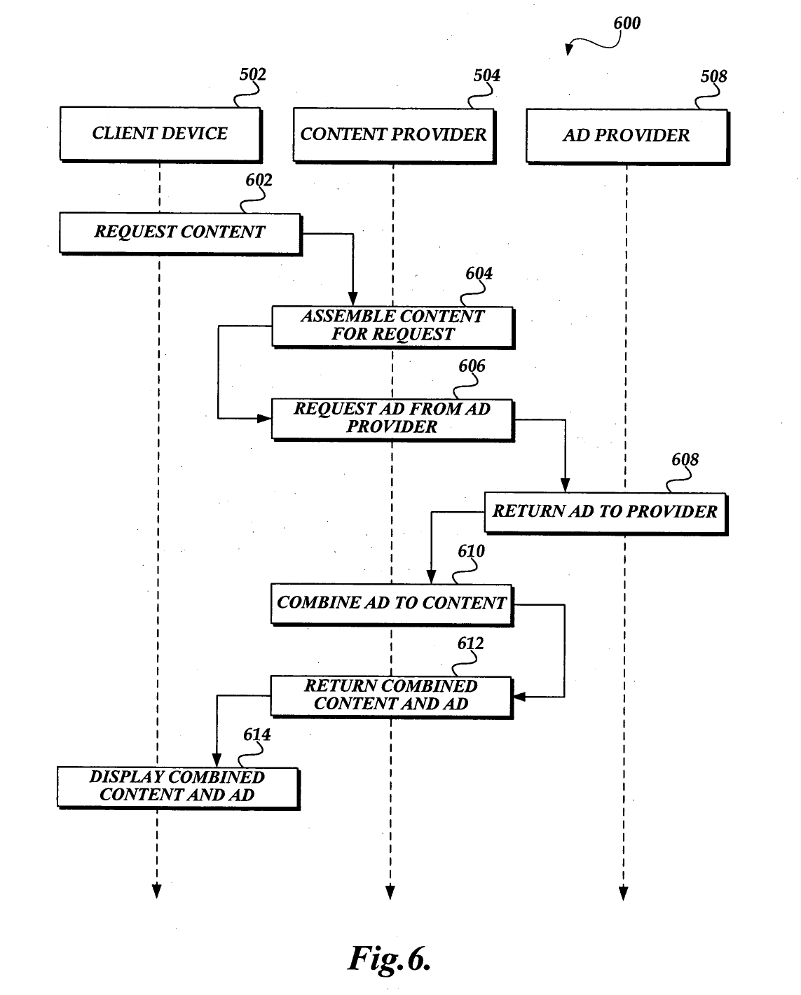

As will be described in greater detail below in regard to FIG. 6, when a content provider 504 receives a content request from a client computer 502, the content provider obtains an advertisement from the ad provider 508. Just as the client computing device 502 and the content provider 504 are in communication, the content provider and the ad provider 508 may also communicate over the Internet 506, or some other communication channel. Additionally, it should be appreciated that while, according to the present discussion, the content provider 504 downloads advertisements from the ad provider 508 upon receiving a client request, it is for illustration purposes only, and should not be construed as limiting upon the present invention. For example, as an alternative to obtaining an advertisement upon receiving a client request, the content provider 504 may obtain advertisements from the ad provider 508 asynchronously to any particular content request. After obtaining an advertisement, the content provider 506 combines the requested content with the advertisement and returns the combination to the client computing device 502.

FIG. 6 is a block diagram illustrating an exemplary exchange 600 between a client device, such as the client computing device 502 of FIG. 5, a content provider 504, and an ad provider 508, for delivering content and a digital watermark advertisement to the client device. The exemplary exchange is illustrated with events that occur at the client device 502, the client provider 504, and at the ad provider 508. An event falling on a line extended below one of the client device 502, the client provider 504, and the ad provider 508 indicates that event takes place on that component.

To begin, at event 602, the client device 502 requests content from the content provider 504. At event 604, the content provider 504 assembles the requested content. Those skilled in the art will realize that assembling may comprise, but is not limited to, retrieving a file, searching for and retrieving data from a database corresponding to the request, retrieving content from other locations distributed throughout the Internet 506, generating the content according to the request, and the like. All of these aspects of assembling the requested content are known in the art.

At event 606, the content provider 504 requests a digital advertisement from the ad provider 508. According to one aspect of the present invention, the request for a digital advertisement may correspond to the subject matter of the content request. At event 608, the ad provider 508 returns a digital advertisement to the content provider 504. According to aspects of the present invention, the digital advertisement obtained from the ad provider 508 is already formed as a digital watermark advertisement. Alternatively, the content provider may be required to process the digital advertisement received from the ad provider 508 to form a digital watermark advertisement.

At event 610, the content provider 504 combines the digital watermark advertisement to the assembled content. As those skilled in the art will recognize, combining the digital watermark advertisement with the assembled content may entail embedding a link in the content to the digital watermark advertisement on the Internet 506 and letting the displaying software on the client device 502 download the actual digital watermark advertisement image for display on the client device. Alternatively, combining the digital watermark advertisement with the assembled content may entail combining the assembled content with the actual digital watermark advertisement image.

At event 612, the content provider 504 returns the combined content and digital watermark advertisement to the client device 502. Thereafter, at event 614, the client device 502 displays the combined content and digital watermark advertisement on its display device.

It should be appreciated that while the content provider 504 and ad provider 508 are illustrated as separate entities, this is a logical separation for illustration purposes and should not be construed as limiting upon the present invention. In one embodiment, a content provider 504 may also be an ad provider 508. Additionally, as discussed above, it should be appreciated that the illustrated exchange of information should be viewed as exemplary only, and should not be construed as limiting upon the present invention. Numerous variations may be made, such as downloading multiple digital advertisements to the content provider 504 prior to and in anticipation of receiving a client request.

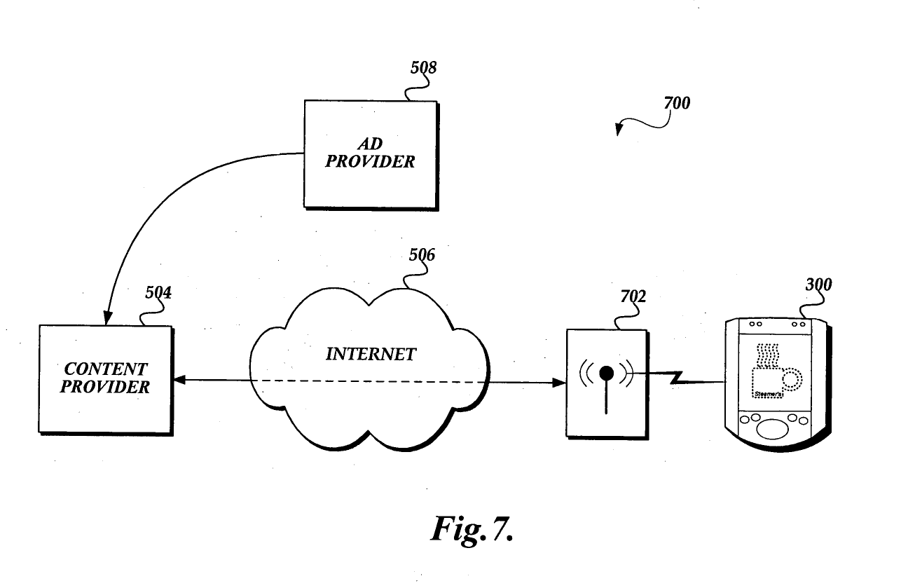

FIG. 7 is a block diagram illustrating an alternative exemplary networked environment 700 suitable for implementing aspects of the present invention. As those skilled in the art will appreciate, many hand-held computing devices, such as PDA 300, communicate wirelessly with a server 710. Thus, the PDA 300 requests content from the content provider 504 via a wireless access point 702. As illustrated in FIG. 7, communication between the content provider 504 and the wireless access point 702 may be over a network, such as the Internet 506. However, it should be understood that the exemplary networked environment 700 is illustrative only. The present invention is not limited to communication with hand-held computing devices over a wireless communication channel.

As will be appreciated by those skilled in the art, communication bandwidth between a wireless computing device, such as PDA 300, and its wireless access point 702 is often limited. Even when the computing device uses a wired connection, the bandwidth available or supported by the computing device may be limited. Thus, in order to alleviate the usage spike that could occur when requesting content combined with a digital watermark advertisement, according to aspects of the present invention, digital watermark advertisements may be pre-loaded onto the PDA 300 prior to a content request. Digital watermark advertisements may be pre-loaded onto a client device, such as PDA 300, directly from ad provider 508 or indirectly from a content provider 504. Advantageously, the digital watermark advertisements may be downloaded during “idle” periods on the client device. What is meant by an “idle” period is those times that the client device, such as PDA 300, is making minimal use of communication bandwidth, and/or is otherwise utilized at less than full capacity.

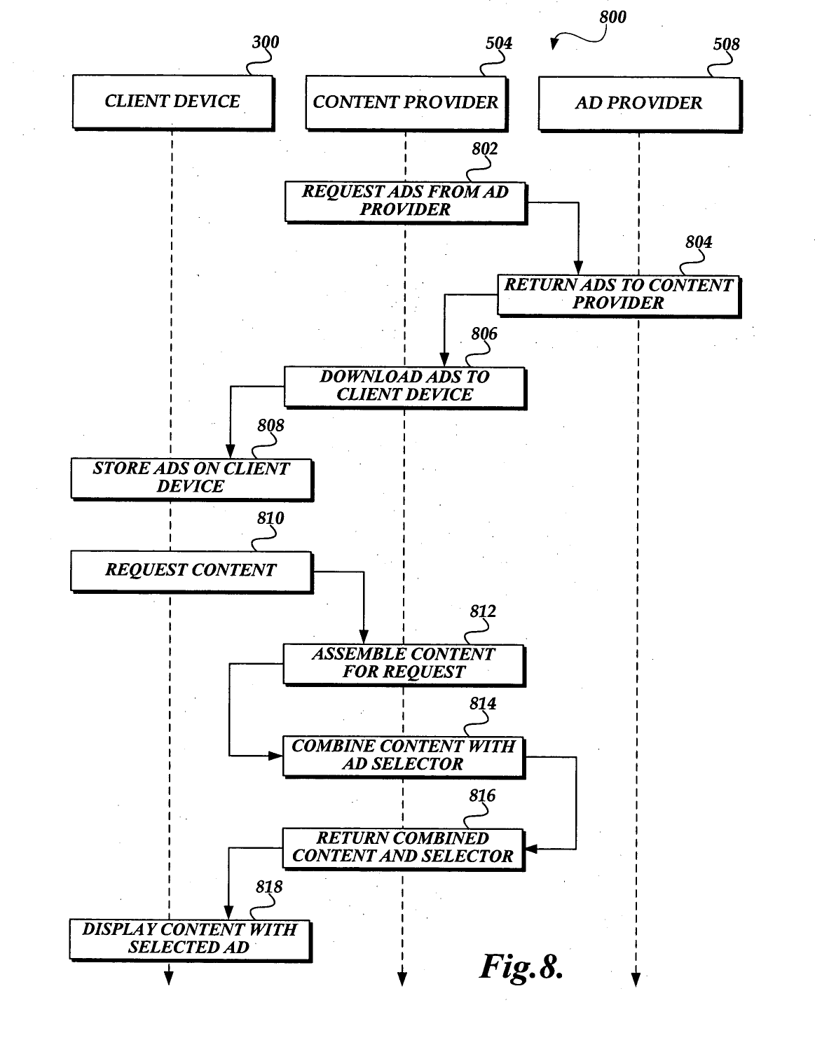

When digital watermark advertisements are pre-loaded/stored on a client device, such as PDA 300, the content provider 504 assembles the requested content and includes an advertisement selector corresponding to a digital watermark advertisement currently stored on the client device. Thus, in displaying the content on the client device's display area, a digital watermark advertisement corresponding to the advertisement selector is displayed, along with the requested content. This aspect of the present invention, i.e., pre-loading a client device with digital watermark advertisements and displaying content with a selected digital watermark advertisement, is described in greater detail in regard to FIG. 8.

FIG. 8 is a block diagram illustrating an alternative exemplary exchange 800 between a client device, such as the PDA 300 of FIG. 3, a content provider 504, and an ad provider 506 for pre-loading digital watermark advertisements to the client device and subsequently selecting a digital watermark advertisement for display with content on the client device. Similar to that of FIG. 6, the exemplary exchange 800 is illustrated with events that occur at a client device 300, a client provider 504, and an ad provider 508. An event falling on a line extended below one of the client device 300, the client provider 504, and the ad provider 508 indicates that event takes place on that component. Additionally, it should be understood that the illustrated exchange 800 is merely exemplary, and should not be construed as limiting upon the present invention. Numerous variations of events may be made without departing from the scope of the present invention.

Beginning at event 802, the content provider 504 requests digital watermark advertisements from the ad provider 506. In response, at event 804, the ad provider 506 returns the digital watermark advertisements to the content provider 504. At event 806, the content provider 504 downloads at least one of the digital watermark advertisements to the client device 702 for subsequent selection and display on the client device. At event 808, the digital watermark advertisements are stored on the client device 702.

At some point after the digital watermark advertisements have been pre-loaded/stored on the client device 702, at event 810, the client device requests content from the content provider 504. At event 812, the content provider 504 assembles the content, as described above, to respond to the request. At event 814, the content provider 504 combines the assembled content with an advertisement selector, the advertisement selector corresponding to one of the digital watermark advertisements pre-loaded/stored on the client device 702. At event 816, the content and the advertisement selector are returned to the client device 702. At event 818, the client device 702 displays the content from the content provider 504 with a pre-loaded digital watermark advertisement selected according to the advertisement selector returned from the content provider.

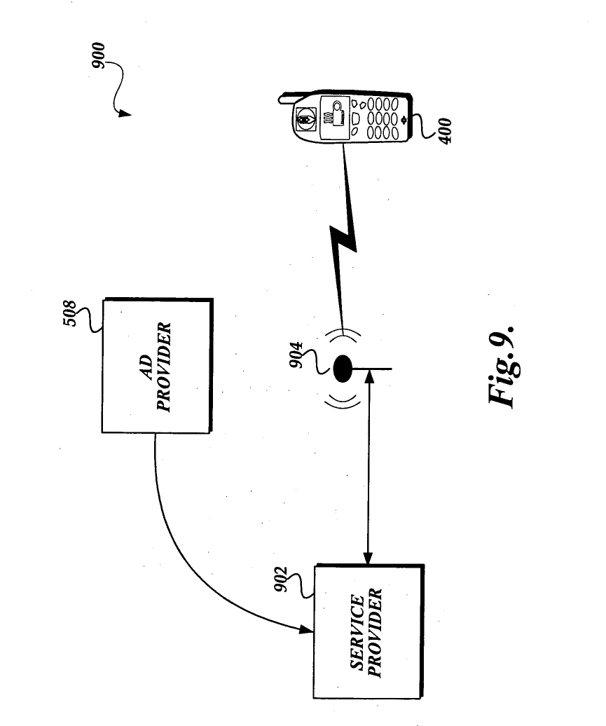

FIG. 9 illustrates yet another exemplary alternative networked environment 900 suitable for implementing aspects of the present invention. In particular, FIG. 9 illustrates an exemplary environment 900 suitable for delivering digital watermark advertisements to a mobile phone 400 (FIG. 4) for display on the mobile phone's display area 402. As those skilled in the art will recognize, while similar to the other exemplary networked environments described above, the mobile phone 400 communicates with or through a service provider 902 via a mobile communication infrastructure 904. As with the other exemplary networked environments, this exemplary networked environment 900 also includes an ad provider 506.

In operation, the exchange between the mobile phone 400 and the service provider 902 may be quite similar to that described above in regard to FIG. 8. More particularly, digital watermark advertisements are downloaded during idle times, such as when the mobile phone 902 is in contact with the mobile communication infrastructure 904, but is not actively communicating, such as when the mobile phone is on and detects an available mobile service, but is not trying to communicate via the service. Thus, the service provider 902, instead of the content provider 504 of FIG. 8, would download the digital watermark advertisements to the mobile phone 400 during the mobile phone's inactive period. However, in contrast to the exemplary exchange in FIG. 8, the service provider 902 may issue advertisement events to the mobile phone 400, an advertisement event including an advertisement selector and indicating to the mobile phone that the digital watermark advertisement pre-loaded onto the mobile phone corresponding to the advertisement selection should be displayed on the mobile phone's display area 402. According to alternative aspects, the mobile phone 400 may itself generate the advertisement events to select and display digital watermark advertisements. These advertisement events may be generated on a periodic basis, or according to particular detected conditions

Clearly, not all users will wish to have digital watermarks advertisements displayed on their client device. While a content provider 504 may mandate that digital watermark advertisements to be displayed with their content, in other situations it could be optional. Thus, according to aspects of the present invention, content providers and/or service providers cause digital watermark advertisements to be displayed on client devices according to whether a user has so consented. For example, a user of any client device, including a computer, a PDA, or a mobile phone, may optionally opt in or opt out of receiving digital watermark advertisements from a content provider 504 and/or a service provider 902. Furthermore, opting in to display digital watermark advertisements on the client device may be associated with a consumer benefit, such as a reduced rate on the services or in making requested content available at no cost.

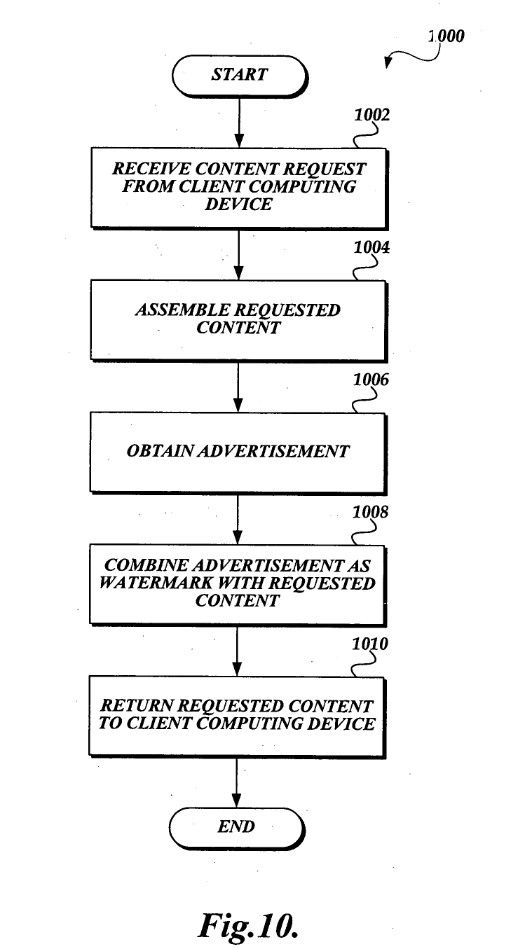

FIG. 10 is a flow diagram illustrating an exemplary routine 1000 executed by a content provider 504 for delivering requested content and a digital watermark advertisement to a client device in response to a content request. Beginning at block 1002, a content request is received from a client device. At block 1004, the content provider 504 assembles, collects, or otherwise generates the requested content. At block 1006, the content provider 504 obtains a digital advertisement from an ad provider 508. At block 1008, the content provider combines the obtained digital advertisement as a digital watermark advertisement with the assembled content. Thereafter, at block 1010, the content provider 504 returns the requested content with the digital watermark advertisement to the client device, and the exemplary routine 1000 terminates.

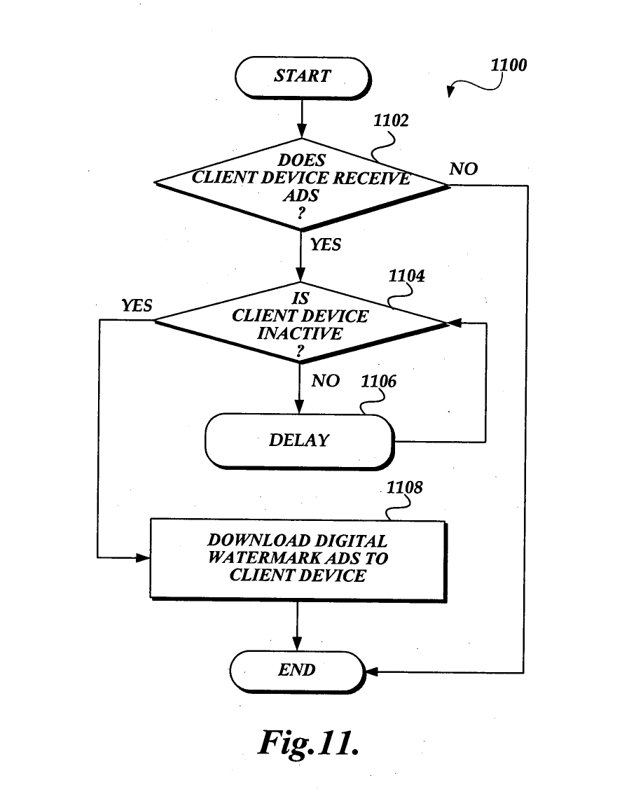

While FIG. 10 illustrates how digital watermark advertisements may be delivered in combination with requested content, as already discussed, it is often advantageous to pre-load digital watermark advertisements onto a client device. Accordingly, FIG. 11 is a flow diagram illustrating an exemplary routine 1100, executed on a content provider 504 and/or a service provider 902, for pre-loading digital watermark advertisements onto a client device for subsequent display. Beginning at decision block 1102, a determination is made as to whether the user of the client device has opted in to receive digital watermark advertisements. If the user has not opted in, i.e., indicated a willingness to receive digital watermark advertisements, the exemplary routine 1100 terminates. However, if the user of the client device has opted in to receive digital watermark advertising from the content provider 504 or service provider 902, at decision block 1104, a further determination is made as to whether the client device is currently idle. For many client devices, such as a mobile phone 400, the client device is idle if it is actively connected to its communication network, such as the Internet 506 or the mobile communication infrastructure 904, but is not actively communicating with another device. However, for some client devices, idle time is less relevant and decision block 1104 may be viewed as an optional decision.

If, at decision block 1104, the client device is not idle, the content provider enters a delay period, as indicated by delay block 1106, after which the routine returns to decision block 1104 to again determine whether the client device is idle. Once it is determined that the client device is idle, at block 1108, the content provider 504 downloads digital watermarks, obtained from an ad provider 508, to the client device. Thereafter, the routine ends.

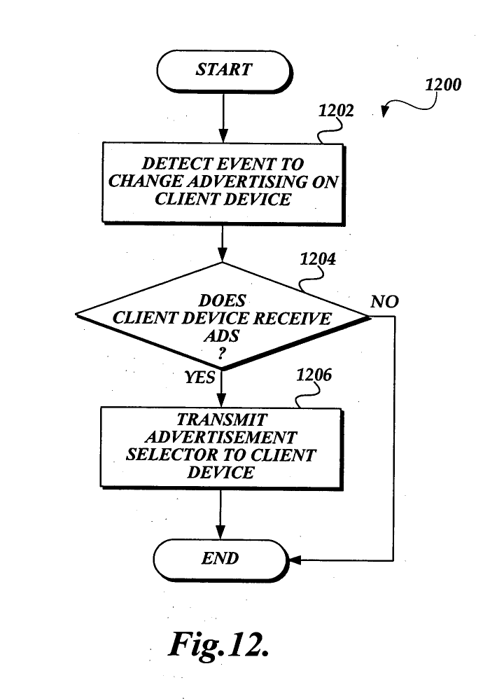

FIG. 12 is a flow diagram illustrating an exemplary routine 1200, executed on a client provider 504, for causing digital watermark advertisements to be displayed on a client device, such as mobile phone 400 or PDA 300. Beginning at block 1202, an event is detected indicating that the content provider should change to the digital watermark advertisement displayed on a client device. The event may be determined on any number of criteria including, but not limited to, a periodic basis, according to an established agreement, the occurrence of particular communication conditions, or at the request of an advertiser or ad provider 508.

At decision block 1204, a determination is made as to whether the user of the client device has opted in to receive digital watermark advertising. If the user has opted in to receive digital watermark advertising on the client device, at block 1206, the content provider 504 transmits an advertisement selector to the client device. Thereafter, or alternatively, if the client device's user has not opted in to receive digital watermark advertising, the routine 1200 terminates. As the event indicating a change to the digital watermark advertisement to be displayed on the client device may be caused by a request from the client computing device for content, or may be caused by a connection established by the client device with another cell phone, the advertisement selector may be transmitted to the client device along with content, or alternatively may simply be transmitted to the client device alone.

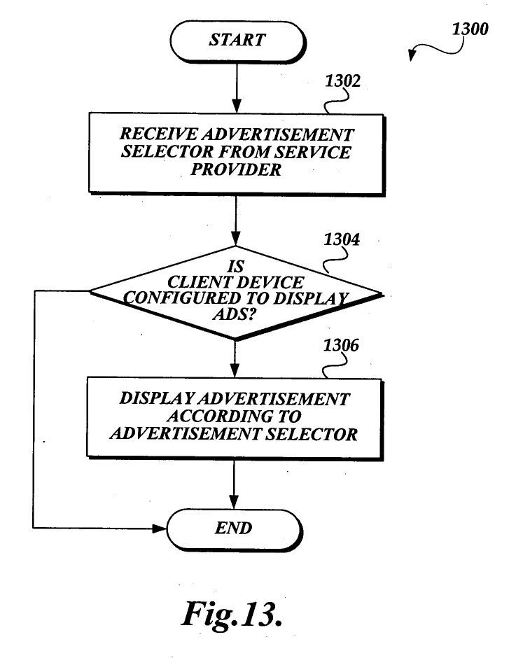

FIG. 13 is a flow diagram illustrating an exemplary routine 1300, executed on a client device, for displaying a digital watermark advertisement according to the advertisement selector sent from a service provider 902. It should be understood that while the following discussion of routine 1300 is made in regard to receiving information from a service provider 902, it is illustrative only, and should not be construed as limiting upon the present invention. As already discussed above, alternatively, the advertisement selector may be from a content provider 504.

Beginning at block 1302, the client device receives an advertisement selector from the service provider 902. At decision block 1304, a determination is made as to whether the client device has been configured to display digital watermark advertisements, i.e., has the client device's user opted in to display digital watermark advertisements. If the client device has been configured to display digital advertisements, at block 1306, a digital watermark advertisement is selected according to the advertisement selector and displayed on the client device's display device. Thereafter, or if the client device has not been configured to display digital watermark advertisements, the routine 1300 terminates.

While various embodiments of the invention have been illustrated and described, including the preferred embodiment, it will be appreciated that various changes can be made therein without departing from the spirit and scope of the invention.

The embodiments of the invention in which an exclusive property or privilege is claimed are defined as follows:

1. A networked environment for displaying a digital advertisement with content in a client device's display area, the networked environment comprising:
a client device having a display area capable of displaying content and a digital advertisement as a digital watermark advertisement;
an ad provider that distributes digital advertisements; and
a content provider communicatively coupled to the client device and to the ad provider, wherein the content provider, in response to a content request from the client device:
combines the requested content with a digital advertisement obtained from the ad provider such that the digital advertisement will be displayed as a digital watermark advertisement with the requested content in the client device's display area; and
returns the requested content with the digital advertisement to the client device for display on the client device's display area.

2. The networked environment of claim 1, wherein the displayed digital watermark advertisement is an interactive digital watermark advertisement.

3. The networked environment of claim 1, wherein the displayed digital watermark advertisement is a dynamic digital watermark advertisement.

4. The networked environment of claim 3, wherein the displayed digital watermark advertisement is also an interactive digital watermark advertisement.

5. The networked environment of claim 1, wherein the client device's display area is the view area of a Web browser running on the client device.

6. The networked environment of claim 1, wherein the client device's display area is the content view area of a non-Web browser application running on the client device.

7. The networked environment of claim 1, wherein the content provider combines the requested content with the digital advertisement obtained from the ad provider only if the user of the client device has indicated a willingness to receive digital watermark advertising.

8. A method for displaying content with a digital watermark advertisement on a client device, the method comprising:
obtaining a plurality of digital advertisements and storing them on the client device;
receiving an advertisement selector for selecting one of the plurality of digital advertisements stored on the client device; and
displaying the digital advertisement selected by the advertisement selector on the client device as a digital watermark advertisement with other content displayed on the client device.

9. The method of claim 8, wherein the client device is a mobile phone and wherein the plurality of digital advertisements are obtained from the mobile phone's service provider.

10. The method of claim 9, wherein the advertisement selector is received from the service provider.

11. The method of claim 10, wherein the advertisement selector is received from the service provider only if the mobile phone's user has indicated a willingness to receive digital advertisements from the service provider.

12. The method of claim 10, wherein the client device receives an advertisement selector from the service provider on a periodic basis.

13. The method of claim 9, wherein the plurality of digital advertisements are obtained from the service provider during the mobile phone's idle times.

14. A method for displaying content and a digital advertisement on a client device while maximizing the display area for the content in the client device's display area, the method comprising:
obtaining a digital advertisement to be displayed in the display area;
displaying the digital advertisement as a digital watermark advertisement in the display area such that the entire display area is available for displaying content; and
displaying content over the digital watermark advertisement in the display area.

15. The method of claim 14, wherein the client device's display area is an Internet browser display area, and wherein the content is obtained from a content provider on the Internet.

16. The method of claim 14, wherein the client device's display area is a non-Internet browser display area.

17. The method of claim 16, wherein the client device's display area is a displayed menu, and wherein the content displayed over the digital watermark advertisement are the displayed menu's items.

18. The method of claim 14 further comprising obtaining a plurality of digital advertisements and storing them on the client device; and
wherein displaying the digital advertisement as a digital watermark advertisement comprises selecting one of the plurality of digital advertisements stored on the client device and displaying the selected digital advertisement as a digital watermark advertisement in the display area.

19. The method of claim 18, wherein obtaining a plurality of digital advertisements and storing them on the client device comprises obtaining the plurality of digital advertisements and storing them on the client device in a background process running on the client device.

20. The method of claim 18, wherein obtaining a plurality of digital advertisements and storing them on the client device comprises obtaining the plurality of digital advertisements and storing them on the client device during the client device's idle times.

21. The method of claim 18, wherein selecting one of the plurality of digital advertisements stored on the client device comprises receiving an advertisement selector corresponding to one of the plurality of digital advertisements stored on the client device, and selecting one of the plurality of digital advertisements stored on the client device according to the advertisement selector.

22. The method of claim 14, wherein the displayed digital watermark advertisement is an interactive digital watermark advertisement.

23. The method of claim 14, wherein the displayed digital watermark advertisement is a dynamic digital watermark advertisement.

24. The method of claim 14, wherein the displayed digital watermark advertisement is a dynamic digital watermark advertisement and an interactive digital watermark advertisement.

25. A method for displaying content and a digital advertisement on a mobile phone device having a display area capable of displaying content and a digital advertisement, the method comprising:
downloading a digital advertisement onto the mobile phone device;
displaying the digital advertisement as a digital watermark advertisement on the mobile phone device's display area; and
displaying other content over the digital watermark advertisement on the mobile phone device's display area.

26. The method of claim 25 further comprising determining whether the mobile phone device's user has indicated a willingness to display digital watermark advertisements on the mobile phone device's display area, and downloading the digital advertisement and displaying the digital advertisement as a digital watermark advertisement on the mobile phone device's display area only if the mobile phone device's user has indicated a willingness to display digital watermark advertisements on the mobile phone device's display area.

27. The method of claim 25 further comprising downloading a plurality of digital advertisements; and
wherein displaying the digital advertisement as a digital watermark advertisement on the mobile phone device's display area comprises selecting one of the plurality of digital advertisements and displaying the selected digital advertisement as a digital watermark on the mobile phone device's display area.

28. The method of claim 27 further comprising receiving an advertisement selector from the mobile phone device's service provider, the advertisement selector corresponding to one of the plurality of digital advertisements stored on the mobile phone device; and
wherein selecting one of the plurality of digital advertisements comprises selecting one of the plurality of digital advertisements according to the advertisement selector.
